(19) United States
(12) Patent Application Publication
(10) Pub. No.: US 2007/0220898 A1
(43) Pub. Date: Sep. 27, 2007

(54) Secondary fuel nozzle with improved fuel pegs and fuel dispersion method

(75) Inventor: William Kirk Hessler, Greer, SC (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/386,017

(22) Filed: Mar. 22, 2006

(51) Int. Cl. F02C 7/22

(52) U.S. Cl. 60/776; 60/740

(57) ABSTRACT

An improved fuel peg for a secondary fuel nozzle is provided that includes at least one slot, thereby to better disperse fuel around the secondary fuel nozzle body, thus providing a more uniform fuel air mixture and more complete combustion.

### BACKGROUND OF THE INVENTION

In an effort to reduce pollution from gas-powered turbines, governmental agencies have enacted numerous regulations requiring reductions in the amount of emissions, especially nitrogen oxide (NOx) and carbon monoxide (CO). Lower combustion emissions can be attributed to a more efficient combustion process, with specific regard to fuel injectors and nozzles. Early combustion systems utilized diffusion type nozzles that produce a diffusion flame, which is a nozzle that injects fuel and air separately and mixing occurs by diffusion in the flame zone. Diffusion type nozzles produce high emissions due to the fact that the fuel and air burn stoichiometrically at high temperature. An improvement over diffusion nozzles is the utilization of some form of premixing such that the fuel and air mix prior to combustion to form a homogeneous mixture that burns at a lower temperature than a diffusion type flame and produces lower NOx emissions. Premixing can occur either internal to the fuel nozzle or external thereto, as long as it is upstream of the combustion zone. An example of a prior art combustion system that uses a form of premixing is shown in FIG. 2.

Referring to FIG. 2, a fuel nozzle 10 of the prior art for injecting fuel and air is shown. This fuel nozzle includes a diffusion pilot tube 11 and a plurality of discrete pegs 12, which are fed fuel from conduit 13. Diffusion pilot tube 11 injects fuel at the nozzle tip directly into the combustion chamber through swirler 14 to form a stable pilot flame.

### BRIEF DESCRIPTION OF THE INVENTION

An improved fuel peg is provided according to a example embodiment of the invention that includes at least one slot, thereby to better disperse fuel around the secondary fuel nozzle body, thus providing a more uniform fuel air mixture and more complete combustion.

Thus, the invention may be embodied in a secondary fuel nozzle assembly for use in a gas turbine combustor, said secondary fuel nozzle assembly comprising: a base; a fuel supply to said base; a nozzle body comprising: an elongated tube having a longitudinal axis and first and second longitudinal ends, said first end of said elongated tube being fixed to and in fluid communication with said base, and a tip region proximate said second end; at least one fuel injector peg extending radially outwardly from and fixed to said elongated tube, at least one said fuel injector peg having at least one slot defined therein for injecting a fuel such that air surrounding said nozzle body mixes with said fuel to form a premixture; and a first passage located within said elongated tube and extending from said first longitudinal end to proximate said at least one fuel injector peg, said first passage being in fluid communication with said fuel supply and said at least one fuel peg.

The invention may also be embodied in a method of dispersing fuel in an air passage around a secondary fuel nozzle assembly having a base, a fuel supply to said base, and a nozzle body comprising an elongated tube having a longitudinal axis and first and second longitudinal ends, said first end of said elongated tube being fixed to and in fluid communication with said base, and a tip region proximate said second end, the method comprising: providing at least one fuel injector peg that extends radially outwardly from said elongated tube, at least one said fuel injector peg having at least one slot defined therein; flowing a fuel from said fuel supply along a first passage within said elongated tube to said at least one fuel injector peg; and injecting said fuel through said at least one slot to form a premixture with air flowing along an outer surface of said nozzle body.

### BRIEF DESCRIPTION OF THE DRAWINGS

FIG. 1 schematically illustrates the location of a secondary fuel nozzle in a combustor;

FIG. 2 schematically illustrates a secondary fuel nozzle having conventional fuel pegs;

FIG. 3 is an enlarged schematic illustration of conventional fuel pegs in a secondary fuel nozzle; and

FIG. 4 is an enlarged schematic perspective view of fuel injection slots in a fuel peg according to an example embodiment of the invention.

### DETAILED DESCRIPTION OF THE INVENTION

The present invention provides an improved fuel peg for a secondary fuel nozzle to provide a more uniform mix of air and fuel and more uniform fuel distribution using at least one curved slot cut into at least one fuel peg rather than the conventional drilled holes for dumping fuel.

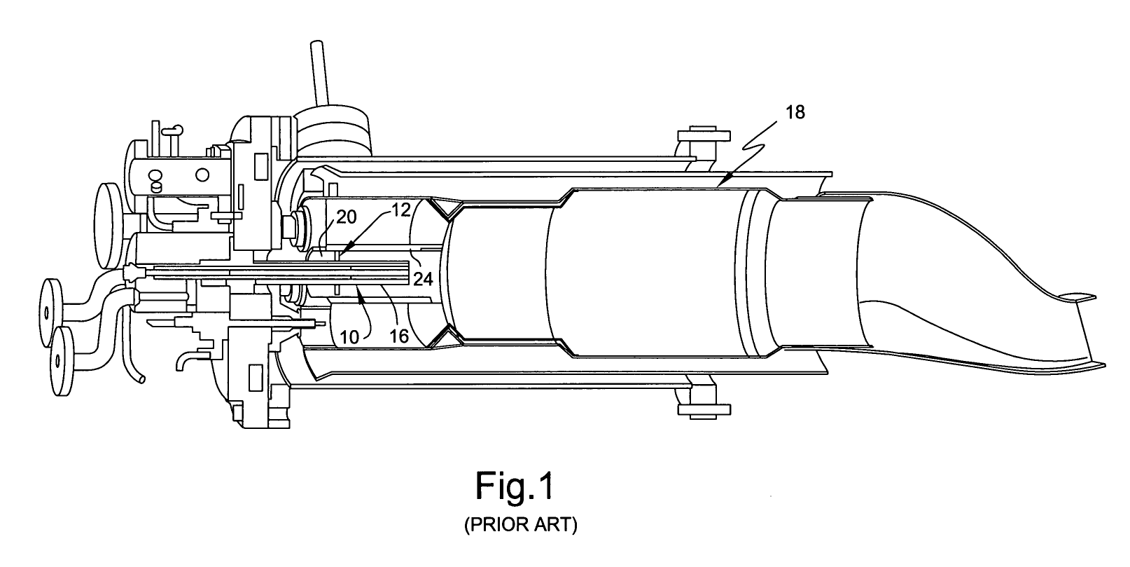

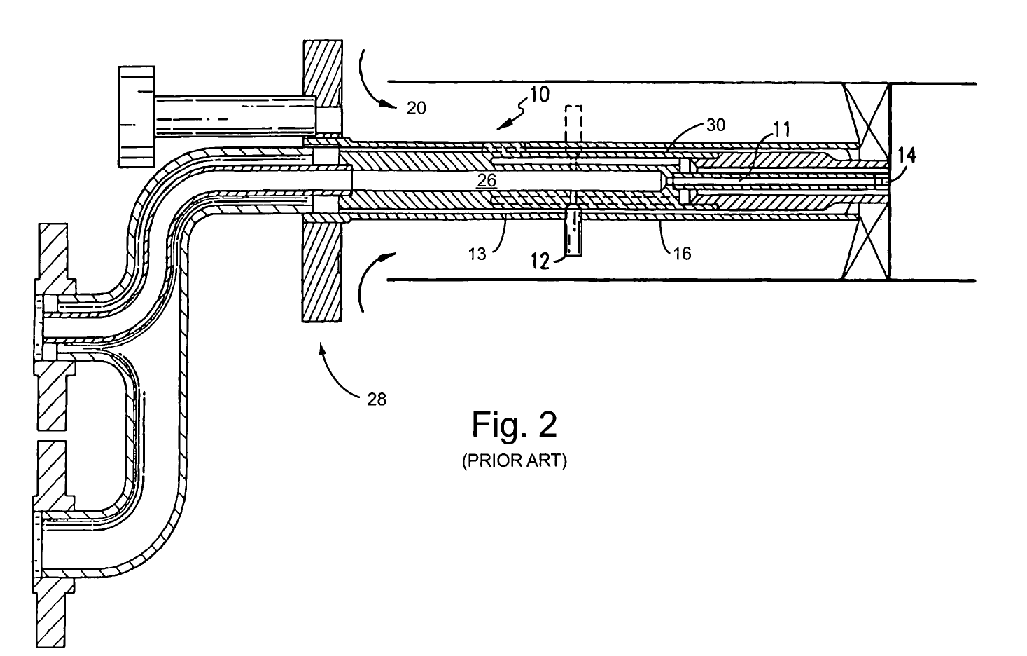

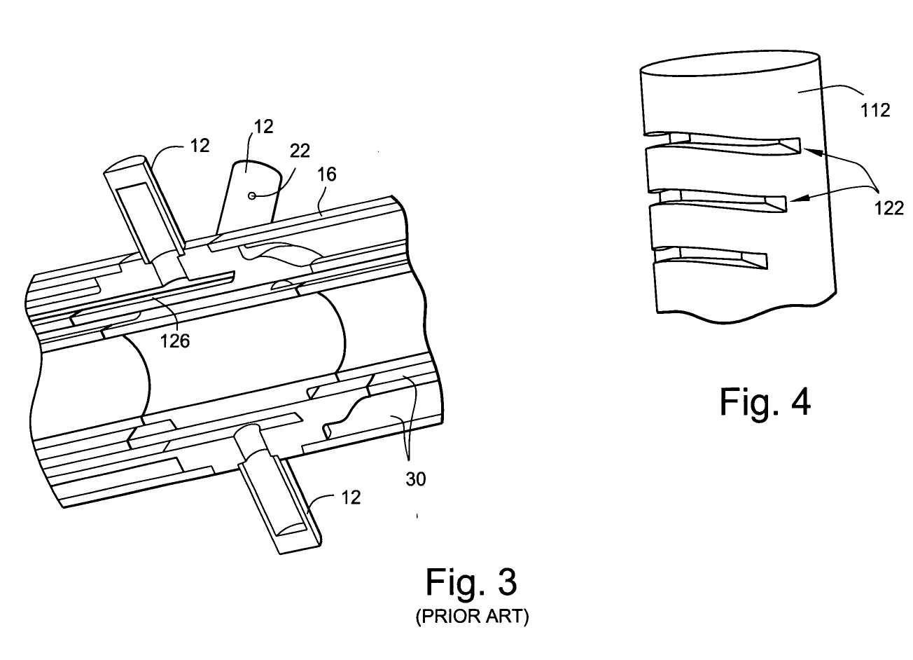

FIG. 1 schematically illustrates a secondary fuel nozzle 10 disposed for injecting fuel into a combustor 18. FIGS. 1, 2, and 3 illustrate the fuel pegs 12 disposed at discrete locations about the outer periphery of the nozzle body 16 for injecting fuel for mixing with air. In the illustration of FIG. 2, at least one passage 26 for fuel extends from the base 28 of the secondary fuel nozzle 10 to a vicinity of the injector pegs 12. FIG. 3 illustrates a nozzle similar to the FIG. 2 structure but defining a concentric passage 126 extending to the fuel pegs 12. Additional passages 30 are defined through the secondary fuel nozzle from upstream of the fuel pegs 12 to the tip 14 of the injector.

The pegs 12 are provided to disperse the fuel; to spray the fuel into the air stream 20 to achieve a premix upstream of the combustion chamber. The purpose of the pegs is to keep the fuel up and off the outer body 16 of the secondary fuel nozzle to avoid fuel wetting the surface and burning the outer tube. In this regard the pegs act as injectors for injecting the fuel into the circumferential air stream 20. Preferably, the fuel is injected so as to avoid stagnation points and possible uncontrolled ignition. Conventionally, round fuel pegs 12 have been used with round fuel dispersion holes 22. However, providing fuel injection holes effectively dumps fuel as a stream into the air.

According to the invention, one or more of the fuel pegs 12 of the structure shown e.g. in FIGS. 1, 2 and/or 3 is replaced with a slotted fuel peg 112. More particularly, the fuel outlet(s) 122 of the fuel injection pegs 112 are slot(s) 122 so as to more effectively spray the fuel in the direction of combustion rather than dump fuel as a stream. Thus, in an example embodiment of the invention, at least one slot opening 122 is defined in one or more of the fuel pegs rather than providing the conventional round fuel dispersion holes.

The provision of a slot 122 more effectively disperses the discharge fuel as an even spray pattern rather than large directed dumping of fuel as happens through the conventional drilled holes 22. In the illustrated example embodiment the slot(s) 122 are curved. In this regard, the secondary fuel nozzle is enclosed in a round tube-like component called the cap center body 24. The slots are advantageously curved to help to distribute the spray more evenly in the circumferential passage defined between the nozzle body 16 and the cap center body 24. It is to be understood, however, that the slots could be formed so as to be straight rather than curved.

In the illustrated embodiment, three slots 122 are depicted in a single fuel peg 112, but it is to be understood that as few as one, or more than three slots could be provided. The size (height and circumferential length) of the slots may be varied depending upon fuel flow required and optimization of mixing. Thus, the illustrated example embodiment is not to be limiting in regard to the size or shape of the respective slots. Furthermore, it is envisioned that a particular slot may have a cross-sectional area generally corresponding to the cross-sectional area of a conventional round fuel dispersion hole, depending however on spray pattern and measured flow and related analysis. Therefore, it is to be understood that the slots in FIG. 4 are disproportionately increased for clarity of concept and is not intended to reflect the proportion of the slots with respect to the fuel pegs, height and width of the slot, or number of slots, since such parameters would be determined based upon fuel flow required, combustor size, fuel type, as well as desired spray pattern, measured flow and analysis. In an example embodiment a cross-sectional area of a slot 122 is about 0.002 to about 0.05 in², more specifically about 0.0038 in² in a non-limiting example embodiment, which is comparable in cross-sectional area to a round hole of about 0.07 inch diameter.

The curved slots of the proposed design allow the fuel to be dispersed between the cap center body 24 and the secondary fuel nozzle 10. This better dispersion of fuel will be carried downstream of the openings to have a better, more uniformed fuel air mixture. Thus, injecting fuel according to an example embodiment of the invention through at least one fuel peg that is slotted avoids stagnation points and possible uncontrolled injection.

Curved slots according to an example embodiment of the invention may be formed using a hole-saw type cutter. The depth to which the cutter cuts determines the width (circumferential length) of the slot and can thus be adjusted to allow more or less fuel to be discharged in the respective slots. Moreover, if a plurality of slots are provided, the dimensions of the slots including at least the width (circumferential length) can be adjusted to vary the amount of fuel discharged closer to, versus farther from, the secondary fuel nozzle body, as schematically shown in FIG. 4.

All fuel pegs of the secondary fuel nozzle could be slotted fuel pegs 112 as proposed herein. In the alternative, both drilled 12 and slotted 112 fuel pegs could be provided. For example, fuel pegs could be alternated to have slots and drilled holes for a desired mixed profile. It is to be understood that the number of slotted pegs, the number of drilled pegs and the number of holes and slots respectively provided in the respective fuel pegs could be varied to provide a desired fuel injection amount and pattern.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A secondary fuel nozzle assembly for use in a gas turbine combustor, said secondary fuel nozzle assembly comprising:
a base;
a fuel supply to said base;
a nozzle body comprising:
an elongated tube having a longitudinal axis and first and second longitudinal ends, said first end of said elongated tube being fixed to and in fluid communication with said base, and a tip region proximate said second end;
at least one fuel injector peg extending radially outwardly from and fixed to said elongated tube, at least one said fuel injector peg having at least one slot defined therein for injecting a fuel such that air surrounding said nozzle body mixes with said fuel to form a premixture; and
a first passage located within said elongated tube and extending from said first longitudinal end to proximate said at least one fuel injector peg, said first passage being in fluid communication with said fuel supply and said at least one fuel peg.

2. The fuel nozzle assembly of claim 1, wherein a plurality of said fuel pegs are provided and disposed to project radially away from said elongated tube about a circumference thereof.

3. The fuel nozzle assembly of claim 2, wherein a plurality of said fuel supply pegs have at least one slot defined therein.

4. The fuel nozzle assembly of claim 2, wherein at least one of said fuel supply pegs has at least one round injector hole for injecting fuel.

5. The fuel nozzle assembly of claim 1, wherein said at least one slot is curved so as to extend generally in parallel to an outer circumference of said elongated tube.

6. The fuel nozzle assembly of claim 1, wherein a plurality of slots are defined in said slotted fuel peg.

7. The fuel nozzle assembly of claim 6, wherein at least one of said slots has a circumferential length different than another of said slots.

8. The fuel nozzle assembly of claim 1, wherein said slotted fuel peg has a substantially circular cross-section.

9. The fuel nozzle assembly of claim 1, wherein said at least one slot is oriented generally in a downstream direction.

10. The fuel nozzle assembly of claim 1, wherein said at least one slot has a cross-sectional area of about 0.002-0.05 square inches.

11. The fuel nozzle assembly of claim 10, wherein said at least one slot has a cross-sectional area of about 0.0038 square inches.

12. A method of dispersing fuel in an air passage around a secondary fuel nozzle assembly having a base, a fuel supply to said base, and a nozzle body comprising an elongated tube having a longitudinal axis and first and second longitudinal ends, said first end of said elongated tube being fixed to and in fluid communication with said base, and a tip region proximate said second end, the method comprising:
providing at least one fuel injector peg that extends radially outwardly from said elongated tube, at least one said fuel injector peg having at least one slot defined therein;
flowing a fuel from said fuel supply along a first passage within said elongated tube to said at least one fuel injector peg; and
injecting said fuel through said at least one slot to form a premixture with air flowing along an outer surface of said nozzle body.

13. The method of claim 12, wherein a plurality of said fuel pegs are provided and disposed to project radially away from said elongated tube about a circumference thereof.

14. The method of claim 13, wherein a plurality of said fuel supply pegs has at least one slot defined therein.

15. The method of claim 13, wherein at least one of said fuel supply pegs have at least one round injector hole, and fuel is also injected through said injector hole.

16. The method of claim 12, wherein said at least one slot is curved so as to extend generally in parallel to an outer circumference of said elongated tube.

17. The method of claim 12, wherein a plurality of slots are defined in said slotted fuel peg and said fuel is injected through said plurality of slots.

18. The fuel nozzle assembly of claim 17, wherein at least one of said slots has a circumferential length different than another of said slots, whereby an amount of fuel injected varies along a length of said fuel peg.

19. The fuel nozzle assembly of claim 1, wherein said at least one slot is oriented generally in a downstream direction, whereby said fuel is injected in a downstream direction.

20. The fuel nozzle assembly of claim 1, wherein said at least one slot has a cross-sectional area of about 0.002-0.05 square inches.
